(19) United States
(12) Patent Application Publication
(10) Pub. No.: US 2021/0020939 A1
(43) Pub. Date: Jan. 21, 2021

(54) ANODE PARTICLES SUITABLE FOR BATTERIES

(71) Applicant: PHILLIPS 66 COMPANY, Houston, TX (US)

(72) Inventors: Zhenhua Mao, Bartlesville, OK (US); Christopher J. LaFrancois, Bartlesville, OK (US)

(73) Assignee: PHILLIPS 66 COMPANY, Houston, TX (US)

(21) Appl. No.: 16/929,210

(22) Filed: Jul. 15, 2020

Related U.S. Application Data
(60) Provisional application No. 62/875,207, filed on Jul. 17, 2019.

(51) Int. Cl. H01M 4/583; H01M 4/133; H01M 4/1393; H01M 10/0525

(52) U.S. Cl. CPC H01M 4/583; H01M 10/0525; H01M 4/1393; H01M 4/133

(57) ABSTRACT

The invention relates to carbon-based electrode material that has been graphitized to hold ions in the electrode of a battery. Preferred batteries include metal ion such as lithium ion batteries where the electrode is the anode. The electrodes are more amorphous then conventional graphite electrodes but are lower cost than coated graphite.

### CROSS-REFERENCE TO RELATED APPLICATIONS

This application is a non-provisional application which claims benefit under 35 USC § 119(e) to U.S. Provisional Application Ser. No. 62/875,207 filed on Jul. 17, 2019 and each entitled “ANODE PARTICLES SUITABLE FOR BATTERIES,” which is incorporated herein in its entirety.

### STATEMENT REGARDING FEDERALLY SPONSORED RESEARCH OR DEVELOPMENT

None.

### FIELD OF THE INVENTION

This invention relates to batteries and particularly to materials useful for making the anode for batteries and more particularly useful for the anode in metal ion batteries.

### BACKGROUND OF THE INVENTION

Rechargeable lithium-ion batteries have been extensively adopted in many portable systems and devices such as cell phones, tablets, computers, handheld portable tools and new devices that are being developed relying on the power and weight of lithium ion batteries. The advantages are light weight, high voltage, high electrochemical equivalence and good conductivity. The broad uses and acceptance of lithium ion batteries has come through many advances and developments. One area of development for lithium-ion batteries has been focused on the anode or negative electrode of lithium-ion batteries where much has been accomplished.

The key considerations for anodes for lithium ion batteries, especially for portable devices is high specific capacity on both volume and weight bases, and long battery life over many multiple charge and discharge cycles. In prior work, anode materials were produced with initial coulombic efficiency approaching 95% and specific capacity approaching 350 mAh/g with high with long life through coated and graphitized carbon precursor materials. This is described in U.S. Pat. No. 7,323,120 to Mao et al. where petroleum coke is ground to a preferred size, subjected to a solvent coating process, having the coating oxidatively stabilized at an elevated temperature and then the whole particle carbonized and graphitized at even higher temperature in an inert environment. The particles formed highly graphitic structures with a protective coating on the surface that protected the underlying graphite sheets from the electrolyte of the battery. The edges of graphite sheets are believed to be catalytically active for the electrolyte which would erode the graphite sheets during the charging cycles quickly reducing the storage capacity for lithium ions in the anode. The coating forms a thin graphite layer with a crystal structure that are not aligned with the underlying and extensive graphite sheets of the core graphite material. The thin coating is resistant to electrolyte decomposition and serves to protect the underlying graphite sheets from the electrolyte while allowing the lithium ions to easily intercalate into and de-intercalate from the anode particles. Indeed, this is very good material with good properties and good cycle life. However, its production requires the use of substantial volumes of solvent along with multiple successive separate heat treatments in different atmospheres, all of which add up to be expensive. But, for high value uses where high specific capacity is needed in a compact space and minimal weight are important, this anode is currently most advantageous.

The most important parameters of graphite negative electrode materials for lithium-ion batteries are the initial coulombic efficiency and specific capacity. It has been well known that highly crystalline graphite powders have high specific capacity and very poor initial coulombic efficiency and are not usable as negative electrode material for lithium-ion batteries. Through many years of extensive research and development, sophisticated processes have been developed to mitigate the problems related to specific capacity and the initial coulombic efficiency; the major solutions concentrate on high temperature graphitization and coating the particles with poorly graphitizable carbon before graphitization to provide protection from the electrolyte for the underlying graphite sheets in the particles. Because the mean average particle size of graphite negative electrode materials is smaller than 30 micrometers and individual particles must be uniformly coated with poorly graphitizable carbon, graphite negative electrode materials are currently manufactured through complicated processing steps. As a result, the production cost is high and for some coating process, product yield is low.

With all materials, higher performance at lower cost are continuous drivers and would be very desirable.

### BRIEF SUMMARY OF THE DISCLOSURE

The invention more particularly relates to a metal ion battery including a cathode, an electrolyte and an anode comprising graphitic powder having a particle range of between 3 and 30 μm formed of graphite precursor material that has been graphitized at a temperature between 2300° C. and 2600° C.

### BRIEF DESCRIPTION OF THE DRAWINGS

A more complete understanding of the present invention and benefits thereof may be acquired by referring to the follow description taken in conjunction with the accompanying drawings in which:

FIG. 1 is a graph showing specific capacity of graphite precursor material, specifically various petroleum cokes, that have been graphitized at various to graphitizing temperature; and

FIG. 2 is a graph showing the initial coulombic efficiencies plotted for the same graphite precursor materials relative to the graphitizing temperatures.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

While coated anode materials have very attractive properties for high value battery uses where the cost of such materials is not prohibitive, there are also uses and needs for electric energy storage where the need for very high performance is less and the sensitivity to cost is higher. Such needs and uses are typically for electric storage where the volume and weight of the battery is very large, and it will stay in a fixed location and not be moved or lugged around such as in a vehicle. An example may be as standby power for a power distribution grid.

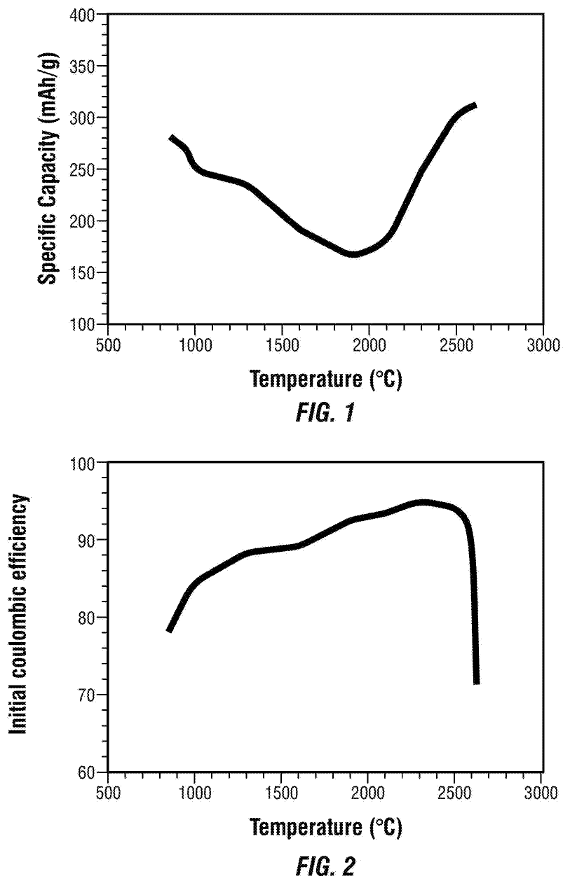

In looking at batteries to meet those needs, efforts by the current inventors have been undertaken to develop graphite precursor materials that are uncoated and simply graphitize them to evaluate their performance. Surprisingly, reasonable performance has been attained if the graphite precursor has been graphitized at a lower temperature that does not propagate the substantial graphite sheets. The particles have an amorphous appearance but show promise. Turning to FIGS. 1 and 2, it turns out that petroleum coke when graphitized at various temperatures show a progression of specific capacity starting at below about 300 mAh/g at about 750° C. graphitization temperature but continues to decline at successively higher graphitization temperatures where the specific capacity minimizes at about 1900 to 2000° C. and then increases dramatically up to just above 2500° C. At the same time, the initial coulombic efficiency expressed as a percentage continues to increase across the same range of graphitization temperatures until it peaks at about 95% near 2500 C and it drops dramatically.

This would suggest that anode material comprising coke whether from petroleum or coal tar could be sized by any of a number of methods to get a preferred particle size and then could be graphitized in an inert atmosphere up to about 2550° C. and perhaps more preferably a little lower, could serve as an effective anode for a metal ion battery. Some coke materials are more easily graphitizable than others such as premium coke is more readily graphitizable than regular grade coke that is typically used to make electrodes for aluminum smelting. In the current invention, the preferred particle size range has a mean average particle size of between about 3 microns up to about 30 microns. The lower graphitization temperatures for this invention as compared to graphitization for coated anode suggest that shorter graphitization time may be possible such as short as 3 to 5 minutes. It is preferred that the graphite is well formed so longer graphitization procedures of two hours or longer would be expected.

### EXAMPLES

The usefulness of such produced materials is assessed as the negative electrode material (lithium intercalation) in coin cells with lithium metal as the counter electrode. The preparation procedure is described below:

Electrode preparation—Each electrode was fabricated with the following steps:

1) About 2 g of the graphitized powder and 0.043 g of carbon black, 0.13 g of polyvinylidene difluoride (PVDF) (in 10 wt % solution (in N-methyl pyrrolidinone (NMP)}, and sufficient extra NMP to make the mixture flowable were placed in a 25-ml plastic vial and shaken with about 3 g of ⅛″ steel balls for 10 min in a mill to form uniform paste.

2) A thin film of the resulting paste was cast on a copper foil or aluminum foil with a doctor-blade coater. The resulting film was dried on a hot plate at 120° C. for at least 2 hours.

3) The dried film was trimmed to a 5-cm wide strip and densified through a roller press

4) Three disks (1.5 cm in diameter) of each film were punched out with a die cutter as electrodes. The electrode weight was determined by subtracting the total weight of each disk by the weight of the disk substrate. The electrode composition was 92 wt % graphite, 6 wt % PVDF, and 2 wt % carbon black, and the mass loading was about 10 mg/cm2.

Each coin cell was subjected to electrochemical tests. The coins each consists of bottom can, lithium metal as the counter electrode, separator, disk electrode, stainless steel disk spacer, wave spring, and top can. These components were sequentially placed in the bottom can. The electrolyte was added to the separator before the disk electrode was stacked. An electrolyte of 1 M LiPF6 in 40 vol % ethylene carbonate, 30 vol % dimethyl carbonate, and 30 vol % diethylene carbonate mixture (purchased from Sigma-Aldrich) was used. After the top can was dropped onto the stack, the assembly was transferred to the coin cell crimper and crimped together.

The electrochemical tests were performed on an electrochemical test station with the different charge/discharge test programs for negative electrode and positive electrode materials, respectively, as follows:

As negative electrode material for lithium-ion batteries—a) charging at a constant current of −1.0 mA to 0.0 V, b) further charging at 0.0 volt for one hour, c) discharging at 1 mA until the voltage reached 2.0 volt, and d) repeated steps a through c 5 times or for 5 cycles. The electrical charge passed during charging and discharging on each cycle was recorded and used to calculate the specific capacity and coulombic efficiency. All the tests were conducted at ambient temperature and the cells were tested in a glove box where 0 2 and moisture levels were below 3 ppm.

Analysis of Carbide and Nitride Forming Element Contents:

After graphitization, the powders are dissolved in acid solution with a proprietary technique. The solutions are analyzed for the elemental contents by standard inductively coupled plasma mass spectrometry (ICP-MS).

### EXAMPLES

Seven samples of green petroleum coke were dried, crushed, and milled to a mean average particle size of 15 μm with laboratory equipment. The seven samples were divided into ten samples each and all 70 samples of the resulting powders were carbonized and graphitized at selected graphitization temperatures between 950° C. and 2650° C. in argon environment. The resulting powders were assessed as the negative electrode material for lithium-ion batteries. The specific capacities and initial coulombic efficiencies of these materials are presented in the charts of FIGS. 1 and 2. A curve is shown in FIG. 1 indicating the specific capacity as it relates to graphitization temperature. A curve is shown in FIG. 2 indicating the initial coulombic efficiency relating to the selected graphitization temperature. The coulombic efficiency reaches the maximum value near 95% within the specified graphitization temperature and the specific capacities are sufficiently high as negative electrode materials for lithium ion batteries. A higher temperature (>2700° C.) is seen to have a detrimentally adverse effect on the coulombic efficiency although the temperature might be slightly lower for more easily graphitizable carbon precursors.

Each of the seven samples demonstrated very overlapping data over the graphitization temperature range thereby forming fairly clear and predictable curves for the specific capacity and initial coulombic efficiency. Following the curves, an optimal range of graphitization for uncoated coke provides useful anode at low cost. So, coke that has been graphitized to a temperature of about 2400° C. to about 2600° C. provides the most optimal specific capacity and initial coulombic efficiency without coating or providing other treatment. It is unclear how the cost could be further reduced using a coke like carbon precursor for the anode.

For battery applications where cost is the primary driver and specific capacity is less important, the anode material from this present invention may be an effective solution.

The above examples have illustrated that useful graphite powders can be economically produced as negative electrode materials for lithium-ion batteries by blending carbide forming compounds or mixture of such compounds.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A metal ion battery comprising:
a cathode;
an electrolyte; and
an anode comprising graphitic powder having a mean average particle size of between 3 and 30 μm formed of graphite precursor material that has been graphitized at a temperature between 2300° C. and 2600° C.

2. The metal ion battery according to claim 1 wherein the graphite precursor materials are particles of coal tar pitch or petroleum coke.

3. The metal ion battery according to claim 1 wherein the graphite precursor coke particles are green coke particles that have not been calcined.

4. The metal ion battery according to claim 1 wherein the mean average size of the graphite precursor particles is between 5 and 25 microns.

5. The metal ion battery according to claim 1 wherein the graphite precursor materials have a carbon content of between 75 and 99%.

6. The metal ion battery according to claim 5 wherein the graphite precursor materials have a carbon content of between 80 and 98%.

7. The metal ion battery according to claim 1 having an initial coulombic efficiency of at least 92% and a specific capacity of at least 250 mAh/g.

8. The metal ion battery according to claim 1 where the graphitic powder has been graphitized to a temperature of between 2300° C. and 2700° C.

9. The metal ion battery according to claim 1 where the graphitic powder has been graphitized to a temperature of between 2400° C. to 2600° C.

10. The metal ion battery according to claim 1 where the graphitic powder has been graphitized to a temperature of between 2450° C. to 2550° C.
